(19) United States
(12) Patent Application Publication
(10) Pub. No.: US 2024/0232114 A1
(43) Pub. Date: Jul. 11, 2024

(54) RELAY DEVICE AND CONTROL METHOD THEREOF

(71) Applicant: BIZLINK INTERNATIONAL CORP., New Taipei City (TW)

(72) Inventors: Chien-Kuan HO, New Taipei City (TW); Tzung-Ling LIN, New Taipei City (TW)

(21) Appl. No.: 18/409,449

(22) Filed: Jan. 10, 2024

(30) Foreign Application Priority Data
Jan. 11, 2023 (TW) 112101267

(51) Int. Cl. G06F 13/40; G06F 13/42

(52) U.S. Cl. CPC G06F 13/4022; G06F 13/4282; G06F 2213/0042

(57) ABSTRACT

A relay device is disclosed. The relay device includes a wired connection circuit, a wireless communication circuit, and a processor. The wired connection circuit is suitable for wired connecting to a user-side electronic device. The wireless communication circuit is suitable for wirelessly connecting to a control-side electronic device. The processor is coupled to the wired connection circuit and the wireless communication circuit. When the wireless communication circuit and the control-side electronic device are wirelessly connected, and the wired connection circuit and the user-side electronic device are wired connected, the processor is configured to transfer a control authority of a first external peripheral device from the control-side electronic device to the user-side electronic device.

### CROSS-REFERENCE TO RELATED APPLICATION

This application claims priority to Taiwan application Ser. No. 11/210,1267, filed Jan. 11, 2023, which is herein incorporated by reference in its entirety.

### BACKGROUND

### Field of Invention

The disclosure relates to a relay device and a control method thereof.

More particularly, the disclosure relates to a relay device and a control method thereof used in a conference room.

### Description of Related Art

The audio switching device can be communicatively connected to several external devices at the same time, and the audio switching device can switch between several audio channels to choose the connected external device.

However, current audio switching devices only provide one-to-one calling functions and cannot achieve three-party listening and calling functions.

### SUMMARY

The disclosure provides a relay device. The relay device includes a wired connection circuit, a wireless communication circuit, and a processor. The wired connection circuit is suitable for wired connecting to a user-side electronic device. The wireless communication circuit is suitable for wirelessly connecting to a control-side electronic device. The processor is coupled to the wired connection circuit and the wireless communication circuit. When the wireless communication circuit and the control-side electronic device are wirelessly connected, and the wired connection circuit and the user-side electronic device are wired connected, the processor is configured to transfer a control authority of a first external peripheral device from the control-side electronic device to the user-side electronic device.

The disclosure provides a control method. The control method is suitable for a relay device. The control method includes the following operations: determining whether a condition is satisfied, wherein the condition includes the relay device and a control-side electronic device wirelessly connected, and the relay device and a user-side electronic device wired connected; and transfer control authority of a first external peripheral device from the control-side electronic device to the user-side electronic device when the condition is satisfied.

The disclosure provides a relay device. The relay device includes a wired connection circuit and a processor. The wired connection circuit is suitable for wired connecting to a user-side electronic device and a control-side electronic device. The processor is coupled to the wired connection circuit. The processor is configured to transfer a control authority of a first external peripheral device from the control-side electronic device to the user-side electronic device when the user-side electronic device and the control-side electronic device are connected to the wired connection circuit at the same time.

It is to be understood that both the foregoing general description and the following detailed description are demonstrated by examples, and are intended to provide further explanation of the invention as claimed.

### BRIEF DESCRIPTION OF THE DRAWINGS

The disclosure can be more fully understood by reading the following detailed description of the embodiment, with reference made to the accompanying drawings as follows:

FIG. 1 is a schematic diagram illustrating a relay device in accordance with some embodiments of the disclosure.

FIG. 2 is a flow chart illustrating a control method in accordance with some embodiments of the disclosure.

FIG. 3 is a schematic diagram illustrating a usage scenario of the relay device in accordance with some embodiments of the disclosure.

### DETAILED DESCRIPTION

Reference will now be made in detail to the present embodiments of the disclosure, examples of which are illustrated in the accompanying drawings. Wherever possible, the same reference numbers are used in the drawings and the description to refer to the same or like parts.

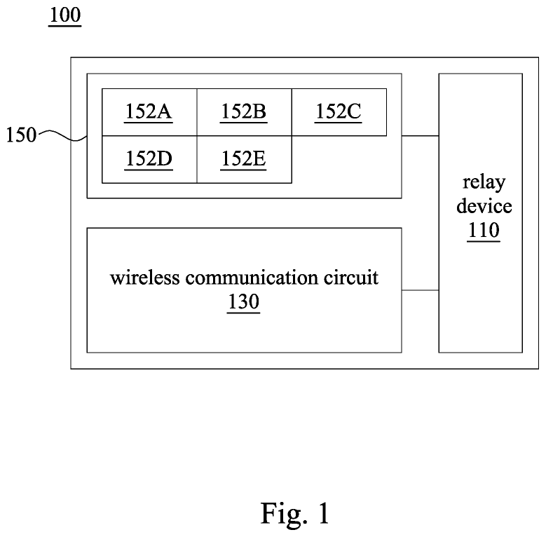

Reference is made to FIG. 1. FIG. 1 is a schematic diagram illustrating a relay device 100 in accordance with some embodiments of the disclosure. As illustrated in FIG. 1, the relay device 100 includes a processor 110 a wireless communication circuit 130 and a wired connection circuit 150. In the connection relationship, the processor 110 is coupled to the wireless communication circuit 130 and the wired connection circuit 150.

The relay device 100 as illustrated in FIG. 1 is for illustrative purposes only, and the embodiment of the present disclosure is not limited to FIG. 1.

In some embodiments, the relay device 100 further includes a memory (not shown). The memory can be a flash memory, an HDD, an SSD (Solid State Drive), a DRAM (Dynamic Random Access Memory) or a SRAM (Static Random Access Memory). In some embodiments, the memory may be a non-volatile computer-readable recording medium storing at least one instruction associated with the control method of the relay device 100. The processor 110 can access and execute at least one instruction.

In some embodiments, the processor 110 can be, but is not limited to, a single processor or a collection of multiple microprocessors, such as a CPU or GPU. A microprocessor electrically coupled to memory to access and execute a control method in response to at least one instruction. For ease of understanding and explanation, the details of the control method will be described in the following paragraphs.

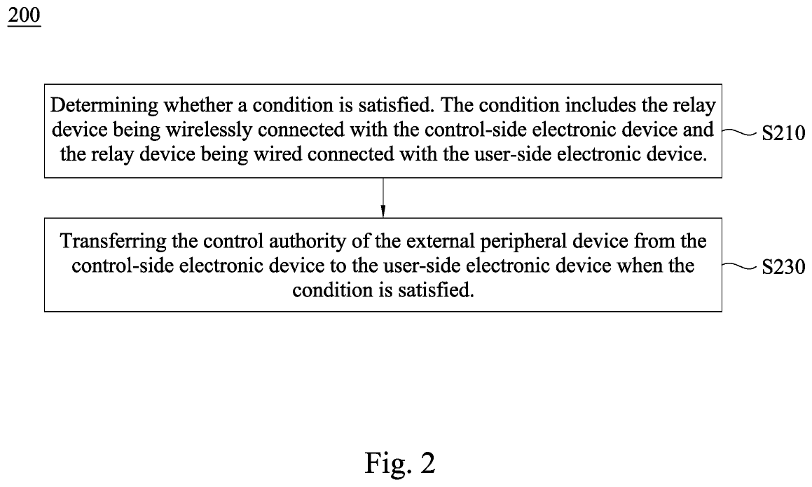

Details of the implementation of the present disclosure are disclosed below with reference to the control method in FIG. 2. FIG. 2 is a flow chart of the control method 200 applicable to the relay device 100 in FIG. 1. However, the embodiments of the present disclosure are not limited thereto.

Reference is made to FIG. 2. FIG. 2 is a flow chart illustrating a control method 200 in accordance with some embodiments of the disclosure.

It should be noted that the control method 200 can be applied to systems with the same or similar structure as the relay device 100 in FIG. 1. In order to simplify the description, FIG. 1 will be used as an example to describe the control method below. However, the embodiments of the present disclosure are not limited to the application of FIG. 1.

It should be noted that, in some embodiments, the control method 200 can also be implemented as a computer program and stored in a non-transitory computer-readable recording medium, so that a computer, an electronic device, or the aforementioned processor 110 as shown in FIG. 1 reads the recording medium and executes the control method. The non-transitory computer-readable recording medium can be a read-only memory, a flash memory, a floppy disk, a hard disk, an optical disk, a pen drive, a magnetic tape, a database accessible from the network, or a person familiar with the art can easily imagine and non-transitory computer-readable recording media with the same functionality.

In some embodiments, the control method 200 can also be implemented as a control circuit, operated and executed by the processor 110.

In addition, it should be understood that the operations of the control method mentioned in this embodiment, unless the order is specifically stated, can be adjusted according to actual needs, and can even be executed simultaneously or partially simultaneously.

Furthermore, in different embodiments, these operations can also be adaptively added, replaced, and/or omitted.

Reference is made to FIG. 2. The control method 200 includes the following operations. For the sake of convenience and clear explanation, the following refers to FIG. 1 and FIG. 2 at the same time. The detailed operation of the control method shown in FIG. 2 is explained by the operating relationship between the components in the relay device 100.

In operation S210, determining whether a condition is satisfied. The condition includes the relay device being wirelessly connected with the control-side electronic device and the relay device being wired connected with the user-side electronic device. In some embodiments, operation S210 is executed by the processor 110 as shown in FIG. 1.

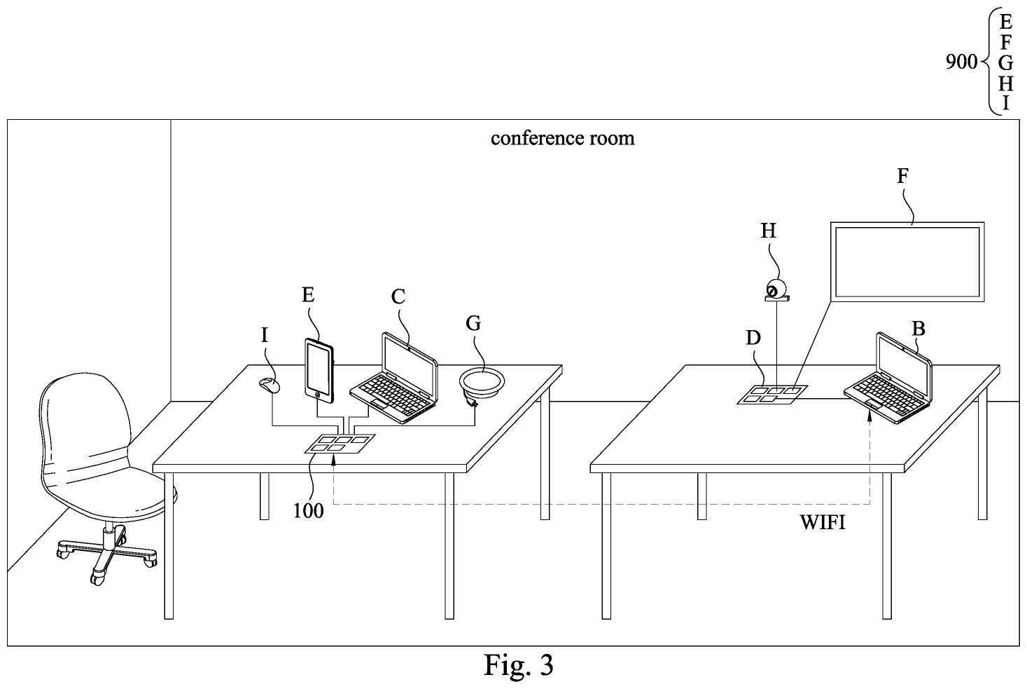

Reference is made to FIG. 3 together. FIG. 3 is a schematic diagram illustrating a usage scenario of the relay device 100 in accordance with some embodiments of the disclosure. In some embodiments, the processor 110 determines whether the wireless communication circuit 130 of the relay device 100 is wirelessly connected to control-side electronic device B, and the processor 110 determines whether the wired connection circuit 150 of the relay device 100 is wired connected to the user-side electronic device C.

When the processor 110 determines that the wireless communication circuit 130 of the relay device 100 is wirelessly connected to the control-side electronic device B, and that the wired connection circuit 150 of the relay device 100 is wired connected to the user-side electronic device C, the processor 110 determines that the condition is satisfied.

In operation S230, transferring the control authority of the external peripheral device from the control-side electronic device to the user-side electronic device when the condition is satisfied. In some embodiments, Operation S230 is executed by the processor 110 as shown in FIG. 1.

Reference is made to FIG. 3 together. In the condition of FIG. 3, the external peripheral device 900 includes the camera H and the screen F. The camera H and the screen F are wired connected to the control-side electronic device B through the hub D.

In some embodiments, the device connected to the relay device 100 can also be used as an external peripheral device 900, such as the microphone I, the tablet E, the speaker G.

It should be noted that, the external peripheral device 900 listed above is for illustration purposes only, and the external peripheral device 900 is not limited to the above.

In some embodiments, when the condition is not satisfied, the control authority of the external peripheral device 900 (including the camera H, the screen F, the microphone I, the tablet E, the speaker G) is in control-side electronic device B. That is, the control-side electronic device B can control the external peripheral device 900.

In some embodiments, when processor 110 determines that the condition is satisfied, The processor 110 transfers the control authority of the external peripheral device 900 from the control-side electronic device B to the user-side electronic device C. That is to say, the user-side electronic device C can control the external peripheral device 900, but the control-side electronic device B cannot control the external peripheral device 900.

Reference is made to FIG. 1 again. In some embodiments, the wired connection circuit 150 further comprises several connection ports 152A to 152E. Several connection ports 152A to 152E includes the control-side preferential connection port and the user-side preferential connection port.

For example, in an embodiment, the connection port 152A the connection port 152 and the connection port 152C are control-side preferential connection ports, and the connection port 152D and the connection port 152E are user-side preferential connection ports.

In some embodiments, in operation S230, when the condition is satisfied, the processor 110 transfers the control authority of the external peripheral device 900 connected to the user-side preferential connection port from the control-side electronic device B to the user-side electronic device C. That is to say, the user-side electronic device C can control the external peripheral device 900 connected to the user-side preferential connection port, while the control-side electronic device B cannot control the external peripheral device 900 connected to the user-side preferential connection port.

On the other hand, in operation S230, when the condition is satisfied, the processor 110 reserves the control authority of the external peripheral device 900 connected to the control-side preferential connection port to the control-side electronic device B. That is to say, the control-side electronic device B can control the external peripheral device 900 connected to the control-side preferential connection port, but the user-side electronic device C cannot control the external peripheral device 900 connected to the control-side preferential connection port.

In some embodiments, the processor 110 determines whether the external peripheral device 900 is connected to the control-side preferential connection port or the control-side preferential connection port, and then, based on the type of connection port to which the external peripheral device 900 is connected to, the processor 110 determines whether the control authority of the external peripheral device 900 needs to be transferred from the control-side electronic device B to the user-side electronic device C.

In the above embodiment, two levels of the connection ports are used as examples for explanation. However, more levels of connection ports are also included in the embodiments of the present disclosure.

In some embodiments, wired connection includes connection methods using physical lines such as universal serial bus cables (USB cables). In some embodiments, wirelessly connection includes wirelessly connected methods such as wireless communication technology (WIFI), etc. Moreover, in one another embodiment, the user-side electronic device C and the control-side electronic device B can select either wired method or wireless method to connect to the processor 110 through the wired connection circuit 150 or the wireless communication circuit 130. In one another embodiment, both user-side electronic device C and the control-side electronic device B can select the wired method to connect to the processor 110 through the wired connection circuit 150 at the same time. In one another embodiment, both user-side electronic device C and the control-side electronic device B can select the wireless method to connect to the processor 110 through the wireless communication circuit 130 at the same time. For any of the connection situations mentioned above, adjustments to the various control authorities mentioned above can be performed as describe with reference to the control method 200 in the previous disclosure.

In summary, the embodiments of the present disclosure provide a relay device and a control method. Through the setting of the relay device, the user does not need to move to the control-side electronic device. The user-side electronic device can control the external peripheral device at a place far away from the control-side electronic device, which is very convenient. In addition, through the settings of different levels of connection ports, the control authority of the external peripheral devices can be further differentiated, which is more flexible.

Although the present invention has been described in considerable detail with reference to certain embodiments thereof, other embodiments are possible. Therefore, the spirit and scope of the appended claims should not be limited to the description of the embodiments contained herein.

What is claimed is:

1. A relay device, comprising:
a wired connection circuit, suitable for wired connecting to a user-side electronic device;
a wireless communication circuit, suitable for wirelessly connecting to a control-side electronic device; and
a processor, coupled to the wired connection circuit and the wireless communication circuit,
wherein when the wireless communication circuit and the control-side electronic device are wirelessly connected, and the wired connection circuit and the user-side electronic device are wired connected, the processor is configured to transfer a first control authority of a first external peripheral device from the control-side electronic device to the user-side electronic device.

2. The relay device of claim 1, wherein the wired connection circuit further comprises:
a control-side preferential connection port; and
a user-side preferential connection port, suitable for connecting the first external peripheral device;
wherein when the user-side preferential connection port is connected to the first external peripheral device, the processor is further configured to transfer the first control authority of the first external peripheral device from the control-side electronic device to the user-side electronic device.

3. The relay device of claim 2, wherein the control-side preferential connection port is suitable for connecting a second external peripheral device, wherein when the second external peripheral device is connected to the control-side preferential connection port, the processor is further configured to reserve a second control authority of the second external peripheral device to the control-side electronic device.

4. The relay device of claim 2, wherein the processor is further configured to determine that the first external peripheral device is connected to the user-side preferential connection port or the control-side preferential connection port.

5. The relay device of claim 1, wherein the processor is further configured to reserve a second control authority of a second external peripheral device to the control-side electronic device when the relay device and the control-side electronic device wirelessly connected, and the relay device and the user-side electronic device wired connected, and the second external peripheral device is connected to a control-side preferential connection port of the relay device.

6. A control method, suitable for a relay device, the control method comprising:
determining whether a condition is satisfied, wherein the condition comprises the relay device and a control-side electronic device wirelessly connected, and the relay device and a user-side electronic device wired connected; and
transferring a first control authority of a first external peripheral device from the control-side electronic device to the user-side electronic device when the condition is satisfied.

7. The control method of claim 6, wherein the control-side electronic device is wired connected to the first external peripheral device through a hub.

8. The control method of claim 6, wherein the condition further comprises the first external peripheral device being connected to a user-side preferential connection port of the relay device.

9. The control method of claim 8, further comprising:
determining that the first external peripheral device is connected to the user-side preferential connection port or a control-side preferential connection port.

10. The control method of claim 6, further comprising:
reserve a second control authority of a second external peripheral device to the control-side electronic device when the condition is satisfied and the second external peripheral device is connected to a control-side preferential connection port of the relay device.

11. A relay device, comprising:
a wired connection circuit, suitable for wired connecting to a user-side electronic device and a control-side electronic device; and
a processor, coupled to the wired connection circuit;
wherein the processor is configured to transfer a first control authority of a first external peripheral device from the control-side electronic device to the user-side electronic device when the user-side electronic device and the control-side electronic device are connected to the wired connection circuit at the same time.

12. The relay device of claim 11, wherein the wired connection circuit further comprises:
a control-side preferential connection port; and
a user-side preferential connection port, suitable for connecting the first external peripheral device;
wherein when the user-side preferential connection port is connected to the first external peripheral device, the processor is further configured to transfer the first control authority of the first external peripheral device from the control-side electronic device to the user-side electronic device.

13. The relay device of claim 12, wherein the control-side preferential connection port is suitable for connecting a second external peripheral device, wherein when the second external peripheral device is connected to the control-side preferential connection port, the processor is further configured to reserve a second control authority of the second external peripheral device to the control-side electronic device.

14. The relay device of claim 12, wherein the processor is further configured to determine that the first external peripheral device is connected to the user-side preferential connection port or the control-side preferential connection port.

15. The relay device of claim 11, wherein the processor is further configured to reserve a second control authority of a second external peripheral device to the control-side electronic device when the user-side electronic device and the control-side electronic device are connected to the wired connection circuit at the same time, and the second external peripheral device is connected to a control-side preferential connection port of the relay device.
